(19) United States
(12) Patent Application Publication
(10) Pub. No.: US 2015/0328761 A1
(43) Pub. Date: Nov. 19, 2015

(54) MULTIPLE PURPOSE UTILITY TOOL

(71) Applicant: Benjamin T. Busch, Mukwonago, WI (US)

(72) Inventor: Benjamin T. Busch, Mukwonago, WI (US)

(21) Appl. No.: 14/712,963

(22) Filed: May 15, 2015

Related U.S. Application Data
(60) Provisional application No. 61/993,515, filed on May 15, 2014.

(51) Int. Cl. B25F 1/00; A01B 1/02

(52) U.S. Cl. CPC B25F 1/006; A01B 1/022

(57) ABSTRACT

A unitary, one-piece multiple purpose utility tool can be used to perform multiple tasks using the same tool. The present invention provides such a device that, when used properly, allows the user to cut, chop, saw, shovel, among other things, while maintaining the structure of a single-piece tool.

This application claims the benefit and priority of U.S. Provisional Patent Application No. 61/993,515 filed May 15, 2014.

### FIELD OF THE INVENTION

The present invention relates generally to various types of utility tools that are used for cutting, sawing, digging, hammering and the like. More specifically, the present invention relates to a single tool that serves multiple purposes including those of the type that would normally be used for each of the above-mentioned functionalities. It also relates to such a multiple purpose utility tool that is relatively compact and light, but extremely sturdy and durable for recreational and military uses. It also relates to such a multiple purpose utility tool that has user safety features that are built into it such that the safety of the user is provided.

### BACKGROUND OF THE INVENTION

Tools have been around since the dawn of time. Indeed, as our ancient ancestors developed skills in the building of shelters and honed other survival skills for themselves, they developed tools to assist them and to make various tasks easier to perform. By definition, a “tool” is broadly considered to be anything that is used as a means of accomplishing a task or purpose. More narrowly, however, a tool is defined as “an implement, especially one held in the hand, as a hammer, saw, or file, for performing or facilitating mechanical operations.” Indeed, people have developed any number of individual tools to perform certain mechanical functions and operations—the shovel to dig; the axe to chop; the saw to cut; the machete to slice; the hammer to drive wedges or nails, and so on. Accordingly, it is well known in the art that individual tools are available for different, but also very specific, uses and that such tools are limited strictly to those uses.

It is also known in the recreational and military activities that there are some utility tools that can be used in different ways and for different purposes. The classic example is the so-called “Swiss Army Knife,” but such a tool is used for more intricate physical activities that are performed on a small scale and definitely not for digging and hammering, for example. In the experience of this inventor, there are other tools that may include structure for performing perhaps two functions, but such tools are typically limited in the number of features that can be used. However, also in the experience of this inventor, there is a clear need for a multiple purpose utility tool that would comprise a wide variety of features into a unitary, one-piece structure. There is also a need for such a tool that can be used by recreational users, such as campers, hikers, and the like, as well as by the military and other users. Lastly, there is a need to provide such a tool that incorporates certain safely features for the safe use of the tool by the user.

### SUMMARY OF THE INVENTION

In view of the foregoing, what is needed is a unitary, one-piece multiple purpose utility tool that can perform multiple tasks using the same tool. The present invention provides such a device that, when used properly, allows the user to cut, chop, saw, shovel, among other things, while maintaining the structure of a single-piece tool. It also provides such a multiple purpose utility tool that is relatively compact and light, but extremely sturdy and durable for recreational and military uses. It also provides such a multiple purpose utility tool that has user safety features built into it such that the safety of the user is designed into the structure.

The foregoing and other features of the multiple purpose utility tool of the present invention will be apparent from the detailed description that follows.

### BRIEF DESCRIPTION OF THE DRAWINGS

FIG. 1 is a first view of the multiple purpose utility tool of the present invention and showing how the tool may be suspended from a user's belt using a carabineer, for example.

FIG. 2 is a first top and side perspective view of the multiple purpose utility tool shown in FIG. 1, with emphasis on a first side edge of the tool.

FIG. 3 is a partial cross-sectioned view of the axe edge portion of the multiple purpose utility tool taken along line 3-3 of FIG. 2.

FIG. 4 is a partial cross-sectioned view of the machete edge portion of the multiple purpose utility tool taken along line 4-4 of FIG. 2.

FIG. 5 is a perspective view that is similar to that shown in FIG. 2 but showing the second side edge of the multiple purpose utility tool of the present invention.

FIG. 6 is a bottom plan view of the multiple purpose utility tool shown in

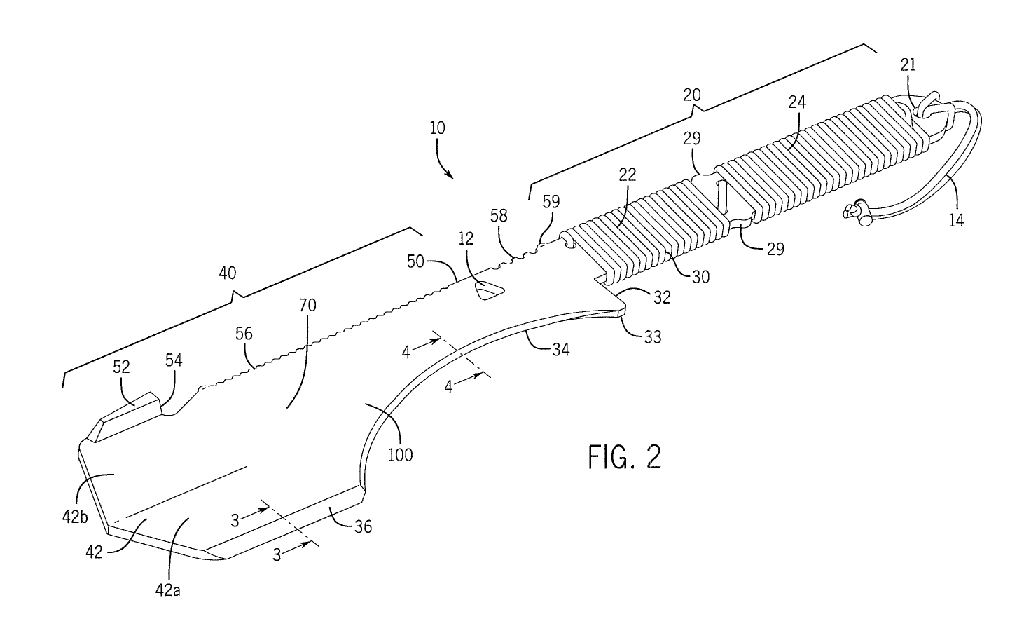

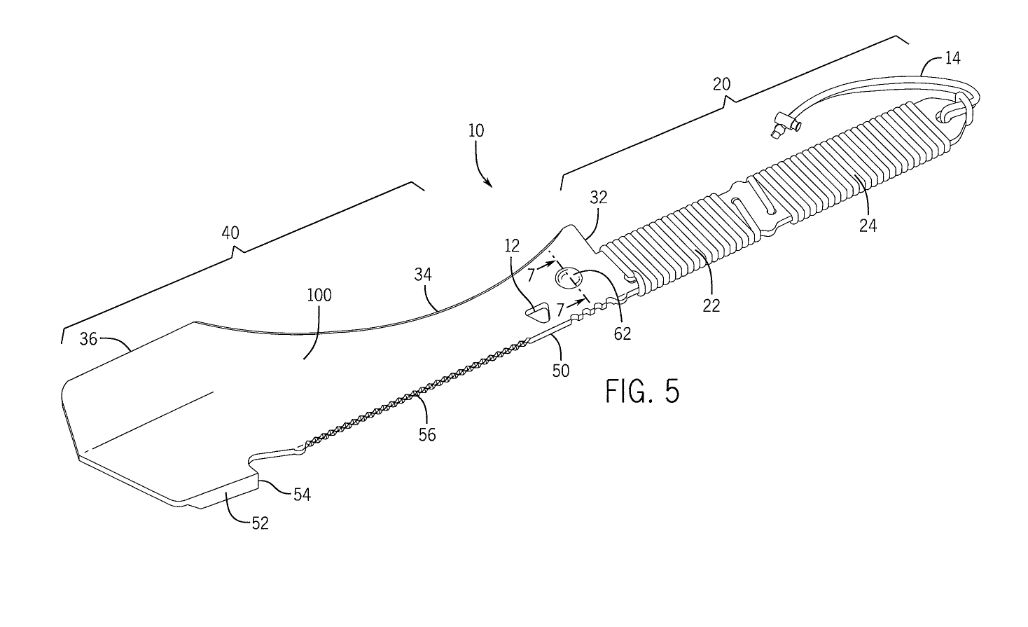

FIGS. 2 and 5.

FIG. 7 is an enlarged partial cross-sectioned view of the bow fire bearing portion of the multiple purpose utility tool taken along line 7-7 of FIG. 5.

FIG. 8 is a greatly enlarged view of a portion of the second edge of the multiple purpose utility tool of the present invention.

FIG. 9 is an enlarged view of the second end of the multiple purpose utility tool of the present invention.

FIG. 10 is a plan view of the second end of the multiple purpose utility tool of the present invention.

FIG. 11 is a view of the first end of the multiple purpose utility tool of the present invention.

### DETAILED DESCRIPTION OF THE INVENTION

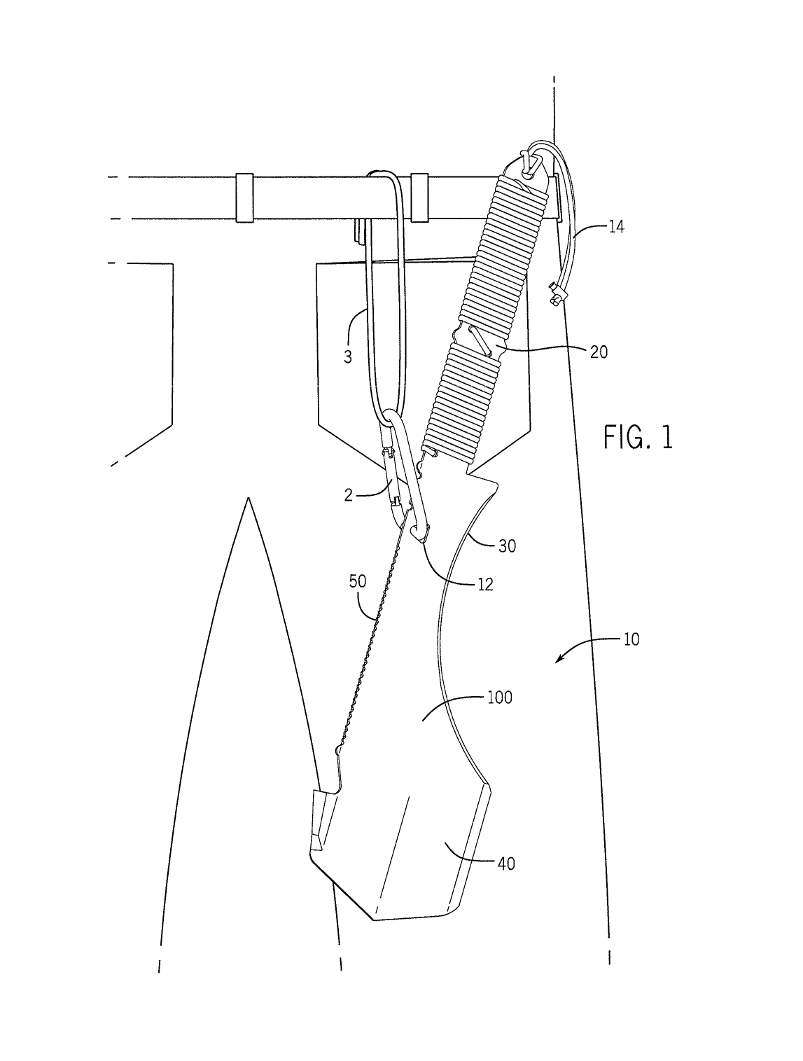

Referring now to the drawings in detail, FIG. 1 is a perspective view showing the multiple use tool, generally identified 10, that is constructed in accordance with the present invention. The tool 10 comprises a substantially flat unitary tool body, generally identified 100, which comprises a first end 20 and a second end 40. The tool 10 further comprises a first edge 30 and a second edge 50. The substantially flat unitary tool body is bounded by the first and second edges 30, 50, respectively. The first edge 30 comprises a plurality of “tool-like” elements or portions, as does the second edge 50, as will be discussed in greater detail below. As recited here and in the claims, the term “tool-like” means that the element or portion referred to comprises characteristics or features that visually resemble or functionally perform as a tool, the tool being given its ordinary meaning. Extending between the edges 30, 50 of the tool 10 is a first face 60 and a second face 70. See also FIG. 2.

Continuing with reference to FIG. 2, it will be seen that the first end 20 comprises a first handle portion 22 and a second handle portion 24. The first end 20 further comprises a lanyard hole 21. A lanyard parachute cord 23 is also wound about the first and second handle portions 22, 24, respectfully. The first and second handle portions 22, 24 are separated by rope bumps 29 along each edge 30, 50 of the first end 20 of the tool 10. Extending downwardly from the first end 20 and along the first edge 30 is a hand bumper 32 which provides protection to the user's forefinger when the tool 10 is used as intended. Extending further downwardly from the first end 20 is a throwing trigger 33, which is not sharp. Next, a curved machete edge portion 34 is provided, as is an axe edge portion 36 and one side 42a of a shovel head 42. The shovel head 42 is disposed at the second end 40 of the tool 10. The shovel head 42 further comprises a second side 42b. See also FIG. 9. The first and second sides 42a, 42b of the shovel head 42 being angled relative to one another.

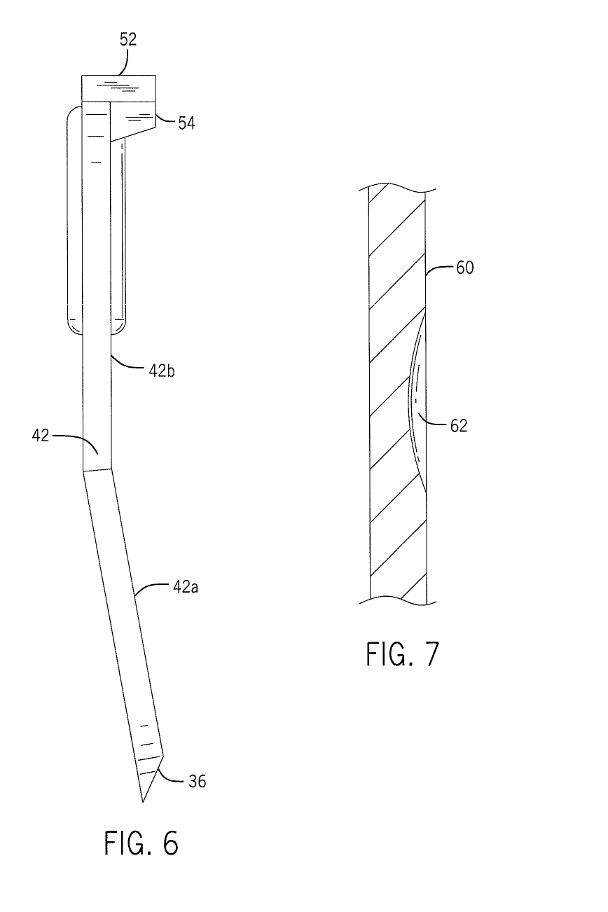

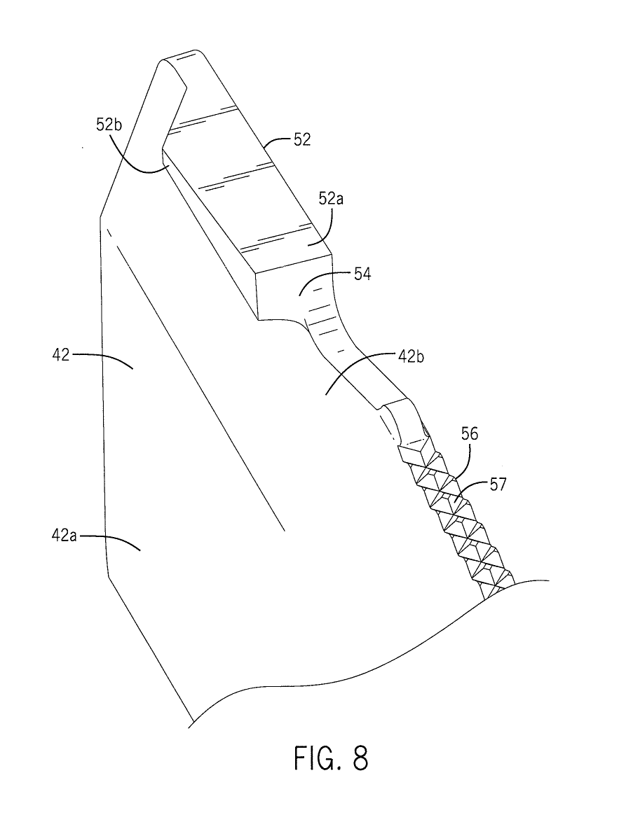

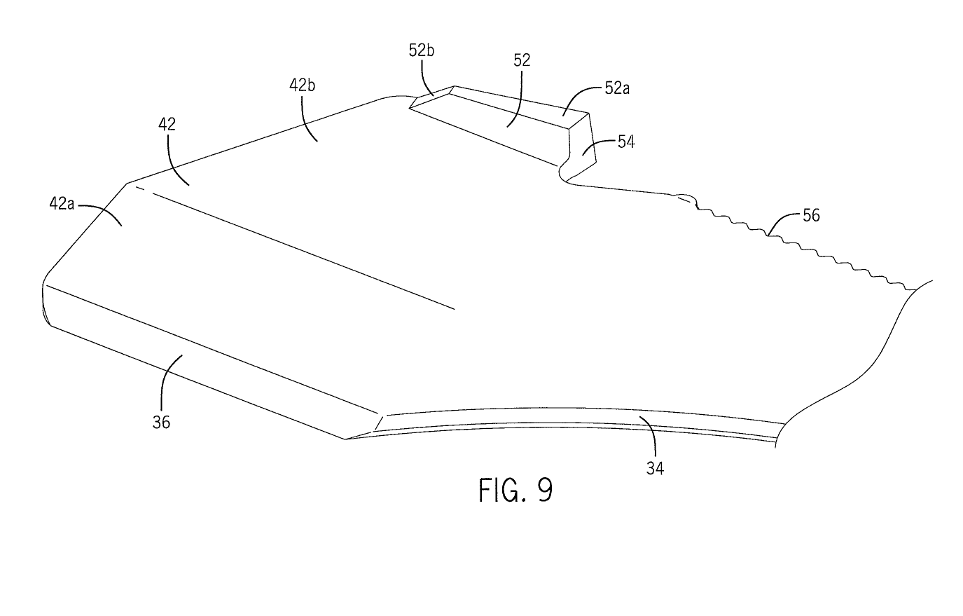

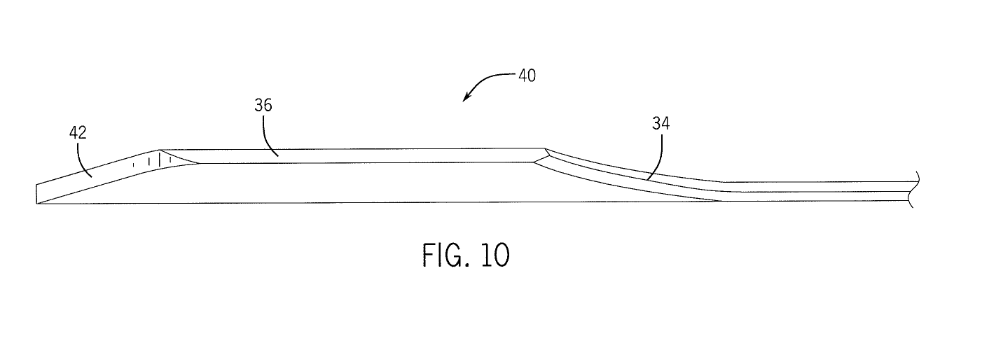

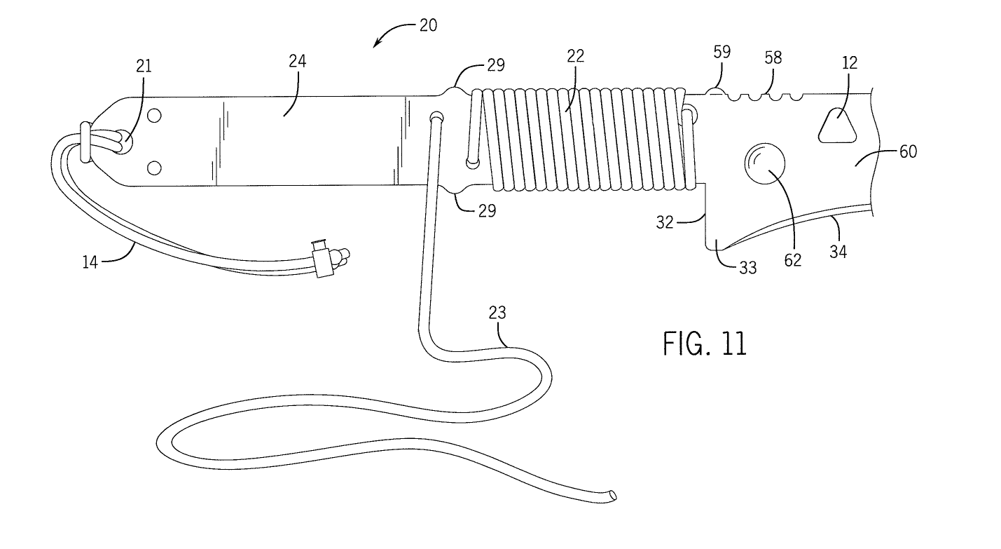

Extending upwardly from the shovel head 42 along the second edge 50 is a combined hammer head and splitting wedge structure 52. Continuing upwardly and along the second edge 50 of the tool 10 is a foot wedge 54, which provides the user with a point at which a user's shoe or boot edge can be placed for driving the shovel head 42 into the ground. Also included along the second edge 50 is a ripping saw 56 which has a cross-hatched pattern 57 for achieving greater and more efficient ripping and coarse cutting during use. See also FIG. 8. The hammer head 52 and splitting wedge 54 are also shown in FIGS. 6 and 8. A thumb grasp 58 is provided for the user's protection and leverage when using the tool 10. Further, a rope bump 59 is also provided. See also FIG. 11.

Disposed between the first end 20 and the second end 40 of the tool 10 is a carabineer hole 12. Again, refer to FIG. 1. The carabineer hole 12 can be used to attach a carabineer 2 to the tool 10 and to a secondary attachment device 3 such that the tool 10 can be carried by a user for use as desired or required. As shown in FIGS. 1, 2, 5 and 11, however, a secondary carrying loop 14 is provided, which loop 14 can wrapped about the user's wrist for secure attachment of the tool 10 to the user when the tool 10 is in use.

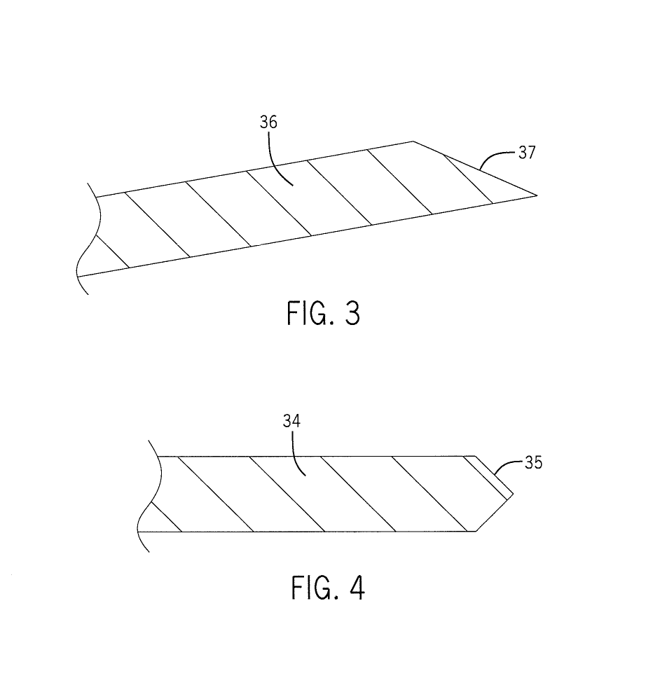

Referring to FIGS. 3 and 6, it will be seen that the axe edge portion 36 comprises a single beveled edge 37. As shown in FIG. 4, the machete edge portion 34 comprises a double beveled edge 35. These edges 35, 37 are provided to allow the user to cut an object much as a single-function device would.

Referring now to FIG. 5, it shows that the second end 40, and the shovel head 42 of the second end 40 comprises a flat portion 41 and a convex portion 43, the convex portion 43 being defined in the first face 60 of the tool 10. This convex portion 43 allows the tool 10 to be used as a digging shovel, the convex portion 43 providing somewhat of a “scoop-like” structure for shoveling and digging.

Referring to FIG. 7, it shows that, defined in the first face 60 of the tool 10, is the fire bow bearing 62 which comprises a circular indentation. See also FIGS. 9 and 10. This bearing 62 allows the user to rotate a stick or other object within the bearing 62 and to start a fire by rapid rotation of the stick within the bearing 62 which creates friction and lights kindling fibers that can be placed about the bearing 62.

Referring now to FIG. 8, it shows a closer view of the combined hammer head and splitting wedge structure 52. This structure 52 allows the used to pound an object with the hammer head portion 52a of that structure 52. The structure 52 is also angled to allow the splitting wedge portion 52b to be used to split objects, such as a log or other piece of wood.

As shown in FIG. 11, the parachute cord 23 can be unwound from the first end 20 of the tool 10 such that the cord 23 can be used for tying the tool 10 to an object (not shown) or for complete removal of the cord 23 from the tool 10 for use of the cord 23 for any use as may be desired or required by the user.

Lastly, it is desirable that the multiple purpose utility tool 10 of the present invention be fabricated as a unitary structure, as mentioned at the outset, and further comprised of a sturdy metal material to maintain the integrity of the tool 10 during use.

Additional advantages and modifications will readily occur to those skilled in the art. Therefore, the invention in its broader aspects is not limited to the specific details disclosed and described herein. Accordingly, various modifications may be made without departing from the spirit or scope of the general inventive concept.

The details of the invention having been disclosed in accordance with the foregoing, I claim:

1. A multiple purpose utility tool that comprises:
a substantially flat unitary body;
a first end;
a second end;
a first face;
a second face;
a first edge, the first edge comprising a plurality of tool-like portions; and
a second edge; the second edge comprising a plurality of tool-like portions.

2. The utility tool of claim 1 wherein the first end comprises a first handle portion and a second handle portion, the first and second handle portions separated by rope bumps along the first and second edges of the first end of the tool.

3. The utility tool of claim 2 wherein a lanyard parachute cord is wound about the first and second handle portions.

4. The utility tool of claim 1 wherein the first end comprises a lanyard hole.

5. The utility tool of claim 2 further comprising a hand bumper along the first edge, just below the handle portions.

6. The utility tool of claim 5 further comprising, just below the hand bumper and along the first edge, a curved machete portion, the curved machete portion comprising a tool-like portion for cutting an object as a machete would.

7. The utility tool of claim 6 further comprising, just below the curved machete portion and along the first edge, an axe edge portion, the axe edge portion comprising a tool-like portion for cutting an object as an axe would.

8. The utility tool of claim 1 wherein the second end comprises a shovel head portion having a first shovel side and a second shovel side, the sides being angled relative to one another, the shovel head being a convex tool-like portion for shoveling and digging as a shovel would.

9. The utility tool of claim 1 further comprising a thumb grasp along the second edge, just below the handle portions.

10. The utility tool of claim of claim 9 further comprising, just below the thumb grasp and along the second side, a straight ripping saw portion comprising a cross-hatched pattern, the ripping saw portion comprising a tool-like portion for ripping and coarse cutting as a ripping saw would.

11. The utility tool of claim 10 further comprising, just below the ripping saw portion, a hammer head portion comprising a tool-like portion for hammering as a hammer head would.

12. The utility tool of claim 11 further comprising, as part of the hammer head portion, a splitting wedge portion comprising a tool-like portion for splitting objects as a splitting wedge would.

13. The utility tool of claim 12 further comprising, as part of the hammer head and splitting wedge portions, a foot wedge which is provided to give the user leverage when using the tool as a shovel.

14. The utility tool of claim 1 further comprising a carrying loop.

15. The utility tool of claim 1 further comprising a fire bow bearing defined in the first face of the tool which allows the tool to be used as a fire starting tool.

16. A multiple purpose utility tool that comprises:
a substantially flat unitary body;
a first end, the first end comprising a first handle portion and a second handle portion, the handle portions being separated by rope bumps along the first and second edges of the first end of the tool;
a second end, the second end comprising a shovel head portion having a first shovel side and a second shovel side, the sides being angled relative to one another, the shovel head being a convex tool-like portion for shoveling and digging;
a first face;
a second face;
a first edge, the first edge comprising:
a hand bumper;
a curved machete portion, the curved machete portion for cutting an object; and
an axe edge portion, the axe edge portion for cutting an object; and
a second edge, the second edge comprising:
a thumb grasp;
a straight ripping saw portion comprising a cross-hatched pattern for ripping and coarse cutting an object;
a hammer head portion for hammering;
a splitting wedge portion for splitting objects; and
a foot wedge to give the user leverage when using the tool as a shovel.

17. The utility tool of claim 16 wherein a lanyard parachute cord is wound about the first and second handle portions.

18. The utility tool of claim 16 wherein the first end comprises a lanyard hole.

19. The utility tool of claim 16 further comprising a carrying loop.

20. The utility tool of claim 16 further comprising a fire bow bearing defined in the first face of the tool which allows the tool to be used as a fire starting tool.
